(19) United States
(12) Patent Application Publication
(10) Pub. No.: US 2014/0282069 A1
(43) Pub. Date: Sep. 18, 2014

(54) System and Method of Storing, Editing and Sharing Selected Regions of Digital Content

(71) Applicant: MAZ DIGITAL INC., New York, NY (US)

(72) Inventors: Paul Canetti, New York, NY (US); Shikha Arora, UP (IN); Simon Baumer, Kailua, HI (US); Manoj Karki, Ghaziabad (IN); Justin Canetti, New York, NY (US)

(73) Assignee: MAZ DIGITAL INC., New York, NY (US)

(21) Appl. No.: 14/211,298

(22) Filed: Mar. 14, 2014

Related U.S. Application Data
(60) Provisional application No. 61/782,861, filed on Mar. 14, 2013.

(51) Int. Cl. H04L 29/08; G06F 3/0484

(52) U.S. Cl. CPC H04L 67/06; G06F 3/04842
USPC 715/748

(57) ABSTRACT

A system and method of storing, editing and sharing selected regions of digital content is described. The system and method include a software application, or tool, executable from any type of network enabled computing device that allows a user to select a region of any size and shape from the digital content and transmit the selected region to another computing device or to an accessible web data feed. The application or tool also associates at least one tag or link with the clipping that directs a user to the source of the clipped digital content when the tag or link is activated. The system and method may also be executable from a digital camera, whereby a user selects any portion of the viewing area prior to executing the snapshot, such that the selected region becomes the saved image, or picture taken, which can then be transmitted to any network enabled computing device.

### CROSS-REFERENCE TO RELATED APPLICATIONS

This application claims priority to U.S. patent application Ser. No. 61/782,861 filed Mar. 14, 2013, the entire disclosure of which is incorporated by reference herein in its entirety.

### BACKGROUND OF THE INVENTION

Unquestionably, informational content, be it for work or entertainment, continues to move towards a digital environment. For example, traditional newspapers and magazines are more typically accessed now as digital content via a computing device, such as a laptop, tablet or smartphone. Similarly, when people are looking for information, they now look to webpages available over the Internet as their resource, instead of going to physical books they own or found in libraries.

Part of the reason for this evolution is the advancement of digital technologies, which now allows for the creation and transmission of all sorts and complexities of visual digital content, including pictures, text and other image based information and materials.

Unfortunately, this evolution includes many drawbacks. For example, one such drawback is that typical content sharing simply shares a hyperlink/URL back to the source of the original content, but does not share any actual content. In other words, all that has actually been shared is a reference to the content instead of the actual content itself. Another drawback is that much of the digital content created requires increased amounts of memory and computing power, to process the digital content, store and transmit that content over a communications network. In effect, there is a tremendous amount of digital content that is simply “too big” to transmit or process, or is otherwise very slow to transmit or process by certain devices or over certain networks. While advancements in connectivity, bandwidth, and download/upload speeds will lessen this burden over time, the need to quickly cut or crop images and visually share the actual content will never be outdated by advances in infrastructure. Part of the reason for this is that the transition from paper to digital has resulted in the loss of certain norms to the reader, such as the feel or even smell of physical paper, as well as the ability to cut or rip things out of the physical page. There is need for creating capturing an equivalent to these nostalgic aspects in the digital realm.

Therefore, there is a need in the art for a system and method of storing, editing and sharing user selected regions of digital content, to effectively capture and transmit not only the real, actual content, but also to capture and transmit the key portions or regions of the digital content desired by the user in a more efficient way. The present invention satisfies this need.

### SUMMARY OF THE INVENTION

The present invention includes a method for sharing a portion of digital content presented on a computing device interface. The method includes the steps of selecting a region of digital content presented on a computing device interface to form a clipping, associating a tag or link with the clipping that directs a user back to the digital content clipped, and presenting the clipping on the computing device interface with at least one selectable option for transmitting the clipping to a remote location via a communications network. In one embodiment, the computing device interface is a touchscreen. In another embodiment, the selecting of a region of digital content comprises a gesture. In another embodiment, the gesture comprises a two finger tap. In another embodiment, the at least one selectable option for transmission is email. In another embodiment, the at least one selectable option for transmission is a tweet. In another embodiment, the at least one selectable option for transmission is an upload to a social network. In another embodiment, the at least one selectable option for transmission is a web data feed. In another embodiment, the shape of the clipping is rectangular. In another embodiment, the shape of the clipping is circular. In another embodiment, the shape of the clipping is free-form. In another embodiment, the method further includes the step of presenting the clipping on the computing device interface with at least one selectable option for saving the clipping to a memory. In another embodiment, the method further includes the step of automating a save function or share function, wherein the clipping on the computing device interface is saved to a memory or transmitted to a remote computing device via a communications network without additional user input or prompting.

The present invention also includes a system for saving portions of visual digital media images. The system includes a clipping tool executable from a network enabled computing device, the clipping tool comprising an adjustable window that defines a perimeter around a portion of a digital media image viewable on a visual display of the computing device to generate a clipping of the digital media image. The clipping tool associates a tag or link with the clipping that is directed to at least a portion of the digital media image and transmits the clipping to a stream of clippings via a data feed, such that individual clippings within the stream of clippings are accessible by a computing device via a communications network. In one embodiment, the tag or link is activated by selecting the clipping within the stream of clippings. In another embodiment, the tag or link is activated by selecting a source button associated with the clipping. In another embodiment, the clipping tool associates at least one selectable option for transmitting the clipping to a remote location via a communications network. In another embodiment, the clipping tool associates at least one selectable option for saving the clipping to a memory separate from the data feed.

The present invention also includes an embedded social network application. The social network application includes a clipping tool executable from a network enabled computing device, the clipping tool comprising an adjustable window that defines a perimeter around a portion of a digital media image viewable on a visual display of the computing device to generate a clipping of the digital media image, and a stream of clippings populated via a data feed of clippings generated by the clipping tool, wherein individual clippings within the stream of clippings are accessible by other computing devices via a communications network, and wherein each clipping includes at least one tag or link directed to the source of the digital media image from which the clipping was generated. In one embodiment, the tag or link is activated by selecting the clipping within the stream of clippings. In another embodiment, the tag or link is activated by selecting a source button associated with the clipping. In another embodiment, the clipping tool associates at least one selectable option for transmitting the clipping to a remote location via a communications network. In another embodiment, the clipping tool associates at least one selectable option for saving the clipping to a memory separate from the data feed.

### BRIEF DESCRIPTION OF THE DRAWINGS

For the purpose of illustrating the invention, there are depicted in the drawings certain embodiments of the invention. However, the invention is not limited to the precise arrangements and instrumentalities of the embodiments depicted in the drawings.

FIG. 1 is a schematic of a system involving a number of computing devices connected to each other via a communications network, according to an aspect of the present invention.

FIG. 2 is a schematic of an alternative of the system of FIG. 1, utilizing a central server and database.

FIG. 3 is an example of digital content in the form of a magazine webpage, according to an aspect of the present invention.

FIGS. 4A and 4B are examples of creating a clipping with a hand gesture.

FIGS. 5 and 6 are examples of large (FIG. 5) and small (FIG. 6) regions of digital content selected for clipping, according to an aspect of the present invention.

FIGS. 7 and 8 are examples of pictorial clippings with selectable transmission or saving options, according to an aspect of the present invention.

FIGS. 9 and 10 are examples of textual digital content, according to an aspect of the present invention.

FIGS. 11 and 12 are examples of different shapes of selected digital content, including rectangular (FIG. 11) and circular (FIG. 12) according to an aspect of the present invention.

FIGS. 13, 14 and 15 are examples of transmitting the selected clipping via email (FIGS. 13 and 15) or tweet (FIG. 14), according to an aspect of the present invention.

FIGS. 16A-16C are an example of selecting a region from the viewing area of a camera in real time (16A), defining a perimeter (16B) and transmitting (16C) the selected region from a camera viewing area, according to an aspect of the present invention.

FIGS. 17A and 17B are another example of selecting a region from the viewing area of a camera in real time (17A), defining a perimeter and transmitting (17B) the selected region from a camera viewing area, according to an aspect of the present invention.

FIG. 18A and B are examples of a clipping stream. FIG. 18A depicts a hand gesture for calling up a clipping stream, and FIG. 18B is a stream of selectable clippings.

FIG. 19 is an example of different types of streams or filtered streams. FIG. 19A is a stream of news clippings, FIG. 19B is a stream of game clippings, and FIG. 19C is a stream of e-commerce clippings.

FIG. 20 is an example of a clipping ready for upload to a social network platform.

### DETAILED DESCRIPTION

It is to be understood that the figures and descriptions of the present invention have been simplified to illustrate elements that are relevant for a clear understanding of the present invention, while eliminating, for the purpose of clarity, many other elements found in digital content selection and sharing systems and methods. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods, materials or components similar or equivalent to those described herein can be used in the practice or testing of the present invention, the preferred methods, materials and components are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20%, ±10%, ±5%, ±1%, and ±0.1% from the specified value, as such variations are appropriate.

The term “digital content” as use herein refers to any kind of electronic file or recordation of information. By non-limiting example, digital content can be in any format, such as a website (HTML), native applications, operating systems, Microsoft Word (.DOC), Microsoft Excel (.XLS), Adobe Acrobat (.PDF), multimedia (.MPEG, .WAV), executable (.EXE), graphic (.GIF, .JPEG), text (.TXT), and any and all formats used to display text, images, video, audio, or other media on a webpage, application, messaging format (MMS, SMS) and the like.

The term “clipping” as used herein may refer to the process of selecting a region or portion of a digital image file, and saving the region or portion as a new image file. Thus, a “clip” may refer to the newly created image file. As used herein, a clip or a set of clippings may be sent, shared or otherwise “streamed” via a communications network.

The term “stream” or “streaming” as used herein may refer to the process of creating a clip or clipping, saving or sharing a clipping, and/or viewing one or more clips in a stream. The stream may also refer to a web feed of a collection of streamed clips that can be accessed or viewed in various configurations. For example, a user may see his or her own stream of clips he or she has streamed. In another example, a user may see a stream of someone else's clips, or an aggregation of clips from a number of other users, such as a filtered set of clips or a results set from a search with a database of streamed clips.

As described herein and illustrated in FIGS. 1-20, the present invention includes a system and method of selecting, “clipping” and/or “streaming” a least a portion of digital content from a first computing device and either saving the clipping to a local or remote memory, or sharing the clipping with a second computing device over a communications network. Accordingly, a user may create his or her own “stream” of clippings, whereby the user can add new clippings or pull clipping to and from their stream, or the user can share any of their clippings with other users. For example, in one embodiment, the system and method includes a software application, or tool, executable from any type of network enabled computing device (or device that can later upload digital content to a second computing device via a network or hardwire connection). In another embodiment, the present invention includes a software development kit or API that allows software developers to implement the clippings tool into other software applications, operating systems, websites, portals and the like, or alternatively as an internet browser extension or other consumer-facing utility that allows a user to stream anywhere from any network enabled device. In another embodiments, the clippings tool may be executable from a digital camera, whereby a user can either clip (or pre-crop) a portion of the digital image snapshot to be taken, or the user can clip a portion of the snapshot taken, such that the camera saves, sends and/or shares (or streams) only the clipped portion of the snapshot. In still other embodiments, the present invention includes a social network platform, where members or visitors of the social network can upload and share their clippings in a personalized stream (or a shared or aggregated stream with multiple users) with other members or visitors, and likewise download and/or view other people's clippings. In certain embodiments, the clipping may include a reference tag or link, such as a metadata tag or link that tracks back to the original source of the content when clipped. In these embodiments, when the clipping is shared or streamed within a social network platform, the tags or links associated with the clipping may also be shared or streamed.

The system of the present invention may operate on a computer platform, such as a local or remote executable software platform or tool, or as a hosted internet or network program or portal. As contemplated herein, any computing device as would be understood by those skilled in the art may be used with the system, including desktop or mobile devices, laptops, desktops, tablets, smartphones or other wireless digital/cellular phones, televisions, cameras or other thin client devices as would be understood by those skilled in the art. Preferably, such computing devices are network enabled or at least capable of connecting to a communications network for subsequent upload or transmission of data via a network or direct hardwire connection.

For example, the system may reside entirely on a single computing device, or may reside on a central server and run on any number of end-user devices via a communications network. The computing devices may include at least one processor, standard input and output devices, as well as all hardware and software typically found on computing devices for storing data and running programs, and for sending and receiving data over a network. If a central server is used, it may be one server or a combination of scalable servers, providing functionality as a network mainframe server, a web server, a mail server and central database server, all maintained and managed by an administrator or operator of the system. The computing device(s) may also be connected directly or via a network to remote databases, such as for additional storage backup, and to allow for the communication of files, email, software, and any other data format between two or more computing devices. There are no limitations to the number, type or connectivity of the databases utilized by the system of the present invention. The communications network can be a wide area network and may be any suitable networked system understood by those having ordinary skill in the art, such as, for example, an open, wide area network (e.g., the internet), an electronic or radio network, an optical network, a wireless network, personal area networks such as Bluetooth or a near field communications network, a physically secure network or virtual private network, and any combinations thereof. The communications network may also include any intermediate nodes, such as gateways, routers, bridges, internet service provider networks, public-switched telephone networks, proxy servers, firewalls, and the like, such that the communications network may be suitable for the transmission of information items and other data throughout the system.

As illustrated in FIG. 1, the present invention may include clippings tool 10, which is resident and executable on one or more computing devices 20, where each device 20 is communicatively connected to each other via network 30. In certain embodiments, clippings tool 10 may be embedded within or run on top of software application 15, such that clippings tool 10 only functions or is only accessible when software application 15 is up and/or running For example, software application 15 may be, without limitation, a digital magazine platform, or the operating system of a digital camera.

In an alternative embodiment and as illustrated in FIG. 2, the system of the present invention may include at least one server 40 having resident therein an OS, GUI and clippings tool 10, at least one database 50 accessible to server 40, network 30, and one or more computing devices 20, where each device 20 is communicatively connected to each other and server 40 via network 30. In such an embodiment, each device 20 accesses and runs clippings tool 10 from server 40 via network 30. When the present invention includes a social network, such network may also reside and run from server 40.

The communications network may also use standard architecture and protocols as understood by those skilled in the art, such as, for example, a packet switched network for transporting information and packets in accordance with a standard transmission control protocol/Internet protocol (“TCP/IP”). Any of the computing devices may be communicatively connected into the communications network through, for example, a traditional telephone service connection using a conventional modem, an integrated services digital network (“ISDN”), a cable connection including a data over cable system interface specification (“DOCSIS”) cable modem, a digital subscriber line (“DSL”), a T1 line, all networking mechanisms utilized by smartphones, or any other mechanism as understood by those skilled in the art. Additionally, the system may utilize any conventional operating platform or combination of platforms (Windows, Mac OS, Unix, Linux, Android, etc.) and may utilize any conventional networking and communications software as would be understood by those skilled in the art.

To protect data, an encryption standard may be used to protect files from unauthorized interception over the network. Any encryption standard or authentication method as may be understood by those having ordinary skill in the art may be used at any point in the system of the present invention. For example, encryption may be accomplished by encrypting an output file by using a Secure Socket Layer (SSL) with dual key encryption. Additionally, the system may limit data manipulation, or information access. For example, a system administrator may allow for administration at one or more levels. A system administrator may also implement access or use restrictions for users at any level. Such restrictions may include, for example, the assignment of user names and passwords that allow the use of the present invention, or the selection of one or more data types that the subservient user is allowed to view or manipulate.

As mentioned previously, the system may operate as application software, which may be managed by a local or remote computing device. The software may include a software framework or architecture that optimizes ease of use of at least one existing software platform, and that may also extend the capabilities of at least one existing software platform. The application architecture may approximate the actual way users organize and manage electronic files, and thus may organize use activities in a natural, coherent manner while delivering use activities through a simple, consistent, and intuitive interface within each application and across applications. The architecture may also be reusable, providing plug-in capability to any number of applications, without extensive re-programming, which may enable parties outside of the system to create components that plug into the architecture. Thus, software or portals in the architecture may be extensible and new software or portals may be created for the architecture by any party.

The system may provide software, for example, the clippings tool and/or the social network, accessible to one or more users to perform one or more functions. Such applications may be available at the same location as the user, or at a location remote from the user. Each application may provide a graphical user interface (GUI) for ease of interaction by the user with information resident in the system. A GUI may be specific to a user, set of users, or type of user, or may be the same for all users or a selected subset of users. The system software may also provide a master GUI set that allows a user to select or interact with GUIs of one or more other applications, or that allows a user to simultaneously access a variety of information otherwise available through any portion of the system.

In certain embodiments, the system software may also be a portal or SaaS that provides, via the GUI, remote access to and from the system of the present invention. The software may include standard applications. The software may also include the ability, either automatically based upon a user request in another application, or by a user request, to search, or otherwise retrieve particular data from one or more remote points, such as on the internet or from a limited or restricted database. The software may vary by user type, or may be available to only a certain user type, depending on the needs of the system. Users may have some portions, or all of the application software resident on a local computing device, or may simply have linking mechanisms, as understood by those skilled in the art, to link a computing device to the software running on a central server via the communications network, for example. As such, any device having, or having access to, the software may be capable of uploading, or downloading, any clippings from the clippings tool, or other information item or data collection item, or informational files to be associated with such files.

Presentation of data through the software may be in any sort and number of selectable formats. For example, a multi-layer format may be used, wherein additional information is available by viewing successively lower layers of presented information. Such layers may be made available by the use of drop down menus, or other layering techniques understood by those skilled in the art or through a novel natural language interface as described hereinthroughout. Formats may also include AutoFill functionality, wherein data may be filled responsively to the entry of partial data in a particular field by the user. All formats may be in standard readable formats, such as XML. The software may further incorporate standard features typically found in applications, such as, for example, a front or “main” page to present a user with various selectable options for use or organization of information item collection fields.

The system software may also include standard reporting mechanisms, such as generating a printable results report, or an electronic results report that can be transmitted to any communicatively connected computing device, such as a generated email message or file attachment. Likewise, particular results of the aforementioned system can trigger an alert signal, such as the generation of an alert email, text or phone call, to alert a manager, expert, researcher, or other professional of the particular results. Further embodiments of such mechanisms are described elsewhere herein or may standard systems understood by those skilled in the art.

As contemplated herein, the system of the present invention may be used on any type of digital content as would be understood by those skilled in the art. For example, as shown in FIG. 3, the digital content may be a page of an online magazine accessible on a computing device. In other examples and as shown in FIGS. 7-12, the digital content may be graphical, pictorial, textual, or any combination of picture and text. The digital content may reside locally on the computing device or it may be located remotely on a different computing device, such as a server, database or other remotely accessed device. It should be appreciated that as long as the digital content is accessible by a computing device via a communications network, that digital content may be suitable for clipping at least a portion thereof.

The application allows the user to clip or stream all or any portion of the digital content. For example, a user of the application may select a region of the digital content in any standard or customized shape. As shown in FIG. 5, the region selected can be a large rectangle, or in FIG. 6, it may be a small square. Also, the selected region may be circular, as shown in FIG. 12. It should be appreciated that the selected region for clipping may be any size and shape, including “free-form” or “hand drawn” shapes. For example, a customized shaped region may be created by a user drawing the shape by dragging a mouse cursor, finger or drawing tool on a touch screen. For standard shapes, the user can select the desired shape from a menu, and similarly drag the standard shape to create a periphery surrounding the region to be clipped. Clips may be created by selection of a clip button, or automatically as set by the application developer or publisher, or as a gesture by the user's fingers. For example, as shown in FIGS. 4A and 4B, a user can create a clipping to stream by tapping with two fingers on a touch screen device, where the two finger touch and/or drag initiates the clipping. It should also be appreciated that the clipping size and shape can further be edited and refined using such gestures as well.

Once the desired region of digital content has been selected for clipping or streaming, the application may highlight the region and present popular transmission mechanisms as selectable buttons to share or stream the clipped region, as shown in FIGS. 5-12, 15, 16C and 17B. Non-limiting examples of such transmission mechanisms include Twitter, Facebook or other social network upload, web data feed, email, MMS, or any other visual communication channel as would be understood by those skilled in the art. In other embodiments, the application may perform an auto-save or auto-share of the clipping instead of presenting a selectable option for saving or transmission. As mentioned elsewhere herein, the clipping may be stored on a local device memory, such that the clipping may function as a visual bookmark, such as for a web browser or eBook, or a visual table of contents comprised of one or more clippings that are linked to specific websites, pages, sections of applications, and the like.

As mentioned previously, a clipping may include a reference tag or link, such as a metadata tag or link, that tracks back to the original source of the content when clipped. Such tags may be permanently associated with the clipping, or they may be temporarily associated with the clipping. For example, in one embodiment, when a clipping is created from digital content accessed via a web browser, a link to the content source site is automatically associated with the clipping, such that when a user subsequently selects the created clipping, or when a user selects a “source” button associated with the clipping, the user is directed via the link to the original content source site. In certain embodiments, the link can direct the user to the entire content of the source site, or it can take them back to a portion of the content, such as to a highlighted portion of the content that represents the visual area previously clipped. In effect, the clipping may itself be a selectable “visual link” to the original source content. In other embodiments, the clipping may be tagged with other types of metadata, such as but not limited to keywords, URLs, comments, “likes”, re-shares, timestamps and the like.

In another embodiment, the clipping may be streamed, such that it is integrated into a web feed of multiple streamed clips that can be accessed or viewed in various configurations. As contemplated herein, a stream may be constructed as a standard web feed data format, as understood by those skilled in the art, for providing users with updated clippings generated by users of the system. The stream may be freely accessible or it may be restricted, such as requiring a user sign in or subscription. Streams may be a single web feed that is personal to a user or they may be an aggregation of user web feeds accessible in a single location. For example, a user can see his or her own clippings he or she has streamed, or see a stream of a different user's clips, or see a stream of aggregated clips from a community of users or a filtered set of users and/or clips. In one embodiment, a stream may be accessed by selection of a stream button, or automatically as set by the application developer or publisher, or as a gesture by the user's fingers. For example, as shown in FIG. 18A, a two finger slide or swipe upward on the device screen may call up a user's stream feed (FIG. 18B). A user's streams may be segregated or filtered, or otherwise organized in any desired manner for viewing. For example, a user may have a stream or filter setting associated with scrollable clippings for news (FIG. 19A), or associated with games (FIG. 19B) or associated with e-commerce (FIG. 19C). It should be appreciated that there is no limit to the organization, presentation or filtering of clippings in a given stream. Further, a user may select any clip from a stream for additional viewing, such as to expand the size or enhance the clip, or to identify the source of the clip from any associated tag or metadata with the clip. Accordingly, in certain embodiments, when the clipping is streamed, or otherwise shared within a social network platform, some or all of the tags or links associated with the clipping may also be shared or streamed, as described previously.

If the user selects email as the mechanism of sharing, as shown in FIGS. 13 and 15, the application generates an email with the clipping region attached or embedded in the email. The user can then add any additional comment to the email prior to sending to one or more recipients, as would be understood by those skilled in the art. Similarly, if the user elects to share the clipped region of digital content as a “tweet,” as illustrated in FIG. 14, the use can integrate the clipped region into the tweet and add any additional commentary as would be understood by those skilled in the art. Alternatively, the application doesn't automatically present transmission buttons, and instead allows the user to manipulate or edit the clipping region prior to transmission or submission to a stream feed.

Further, any clipping may be simultaneously or alternatively stored, either locally on the computing device or remotely on a server or other storage device (in the cloud), or as a data feed (stream), such that the clipping may be accessible by the user at a later point in time for viewing, editing, sharing or other desired use. For example, a present invention may include a default save to a stream, wherein when the user creates a clip, it is automatically saved into an ongoing feed of clips (the stream) that is visible to the user or other users granted access to the stream.

In another embodiment of the present invention, the clippings tool may be integrated into a still or video camera, such that a user may select any portion of the viewing area prior to executing the snapshot, such that the selected region becomes the clipping or saved image in a stream, or in other words, the actual picture taken. Accordingly, the clipping may be tagged and streamed as described hereinthroughout like any clipping image. Such still or video cameras may include, without limitation, a stand-alone device, or a camera built into a smartphone, tablet, or wearable hardware, such as a pair of glasses. In effect, the present invention allows a user to clip a region of the viewing area in real time, creating the effect of clipping “real life” through the camera lens. In certain embodiments, the tool may also be described as pre-cropping, where a user chooses only a section of the content visible through the lens/viewfinder/screen to clip and save and/or transmit into a stream. For example, as shown in FIGS. 16A and 17A, the user may select a desired region of the camera viewing area in any desired size and shape by any of the mechanisms described herein. Once the desired region is selected, as shown in FIGS. 16B, 16C and 17B, the application may highlight the region and present popular transmission mechanisms as selectable buttons to share the clipped region according to any of the mechanisms previously described. As contemplated herein, the camera may integrate all other features of a camera, such as focusing, flash, light/dark or contrast effects as would be understood by those skilled in the art, and even a “zoom” of the selected region for clipping.

The present invention also includes a social networking platform based around what users have clipped or streamed, thereby creating a community of members and visitors who may share their clippings, and post comments on such clippings. As contemplated herein, the clippings tool may be integrated into the social network, such that the clippings tool presents a preferred or quick upload button for a user once the user has selected the region of digital content to be clipped, as shown in FIG. 20. In certain embodiments, the social network can be used to not only post and comment on clippings, but further as way of requesting and searching for clippings as desired by one or more community members. For example, a first member can request a clipping, either for payment or simply in a game format, where other community members search available digital media or “real life” images to create a clipping that meets the requirements of the request. The social network may otherwise function as typical social networks, as would be understood by those skilled in the art. In another example, the clippings social network may take the form of a “visual Twitter” network, where publicly and/or privately available streams of clippings are accessible by users of the network. Such streams may be, by non-limiting example, of a particular brand or publisher, of a particular user, of a group of users, by category or tag, or by a source. Likewise, users can follow each other's clippings, re-clip content, and visit links associated with the clippings by selecting the link to obtain access. In yet another example, a user can go to a particular website or application, and can see what other people are clipping and have clipped from it.

As contemplated herein, the social network may be a stand-alone service, a software application or website, or it may be integrated into or embedded within existing platforms, such that the present invention forms an embedded social network of users interactive via one or more streams. For example, the present invention may be an application that runs on top of a digital magazine platform that allows subscribing users of the platform to stream their clippings from the magazine, such that the clippings within the stream can be saved, shared, discovered and commented on by other magazine subscribing users in the manner of a mini social network of subscribing users.

The disclosures of each and every patent, patent application, and publication cited herein are hereby incorporated herein by reference in their entirety.

While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed:

1. A method for sharing a portion of digital content presented on a computing device interface, comprising:
selecting a region of digital content presented on a computing device interface to form a clipping;
associating a tag or link with the clipping that directs a user back to the digital content clipped; and
presenting the clipping on the computing device interface with at least one selectable option for transmitting the clipping to a remote location via a communications network.

2. The method of claim 1, wherein the computing device interface is a touchscreen.

3. The method of claim 2, wherein the selecting of a region of digital content comprises a gesture.

4. The method of claim 3, wherein the gesture comprises a two finger tap.

5. The method of claim 1, wherein the at least one selectable option for transmission is email.

6. The method of claim 1, wherein the at least one selectable option for transmission is a tweet.

7. The method of claim 1, wherein the at least one selectable option for transmission is an upload to a social network.

8. The method of claim 1, wherein the at least one selectable option for transmission is a web data feed.

9. The method of claim 1, wherein the shape of the clipping is rectangular.

10. The method of claim 1, wherein the shape of the clipping is circular.

11. The method of claim 1, wherein the shape of the clipping is free-form.

12. The method of claim 1, further comprising presenting the clipping on the computing device interface with at least one selectable option for saving the clipping to a memory.

13. The method of claim 1, further comprising automating a save function or share function, wherein the clipping on the computing device interface is saved to a memory or transmitted to a remote computing device via a communications network without additional user input or prompting.

14. A system for saving portions of visual digital media images, comprising:
a clipping tool executable from a network enabled computing device, the clipping tool comprising an adjustable window that defines a perimeter around a portion of a digital media image viewable on a visual display of the computing device to generate a clipping of the digital media image;
wherein the clipping tool associates a tag or link with the clipping that is directed to at least a portion of the digital media image and transmits the clipping to a stream of clippings via a data feed, such that individual clippings within the stream of clippings are accessible by a computing device via a communications network.

15. The system of claim 14, wherein the tag or link is activated by selecting the clipping within the stream of clippings.

16. The system of claim 14 wherein the tag or link is activated by selecting a source button associated with the clipping.

17. The system of claim 14, wherein the clipping tool associates at least one selectable option for transmitting the clipping to a remote location via a communications network.

18. The system of claim 14, wherein the clipping tool associates at least one selectable option for saving the clipping to a memory separate from the data feed.

19. An embedded social network application, comprising:
a clipping tool executable from a network enabled computing device, the clipping tool comprising an adjustable window that defines a perimeter around a portion of a digital media image viewable on a visual display of the computing device to generate a clipping of the digital media image; and
a stream of clippings populated via a data feed of clippings generated by the clipping tool, wherein individual clippings within the stream of clippings are accessible by other computing devices via a communications network, and wherein each clipping includes at least one tag or link directed to the source of the digital media image from which the clipping was generated.

20. The application of claim 19, wherein the tag or link is activated by selecting the clipping within the stream of clippings.

21. The application of claim 19, wherein the tag or link is activated by selecting a source button associated with the clipping.

22. The application of claim 19, wherein the clipping tool associates at least one selectable option for transmitting the clipping to a remote location via a communications network.

23. The application of claim 19, wherein the clipping tool associates at least one selectable option for saving the clipping to a memory separate from the data feed.
